(19) United States
(12) Patent Application Publication
(10) Pub. No.: US 2003/0052438 A1
(43) Pub. Date: Mar. 20, 2003

(54) Method for forming golf ball subassemblies

(76) Inventors: William Brum, Raynham, MA (US); Stephen K. Scolamiero, Bristol, RI (US)

Correspondence Address: Troy R. Lester, Acushnet Company, 333 Bridge Street, Fairhaven, MA, 02719, US

(21) Appl. No.: 10/280,900

(22) Filed: Oct. 25, 2002

Related U.S. Application Data
(63) Continuation-in-part of application No. 09/924,348, filed on Aug. 8, 2001.

(51) Int. Cl. B29C 43/02; B29C 71/00; B29C 71/02

(52) U.S. Cl. 264/236; 264/297.5; 264/297.8; 264/237; 264/320; 264/325

(57) ABSTRACT

The present invention is directed to a method of forming a golf ball subassembly. After forming a partially-cured golf ball subassembly, the partially-cured subassembly is placed in a medium to continue curing until it is a substantially-cured subassembly. The medium in this embodiment is heated air and the subassemblies are moved through the heated air on a spiraled path. Subsequent to substantially curing the subassembly, it can be cooled in a cooling unit with a spiraled path. In one embodiment, the subassembly is a core, in another embodiment the subassembly is a core with a castable material thereabout.

### STATEMENT OF RELATED APPLICATION

This patent application is a continuation-in-part of co-pending U.S. patent application Ser. No. 09/924,348 entitled “Method For Forming Golf Ball Cores” and filed on Aug. 8, 2001. This parent application is incorporated herein by reference in its entirety.

### FIELD OF THE INVENTION

The present invention relates to a method for forming golf ball subassemblies and, in particular, a method for curing cores or other components of a golf ball while reducing molding time.

### BACKGROUND OF THE INVENTION

Balls having a two-piece construction or multi-layer construction are generally most popular with the average recreational golfer, because these balls are a very durable and provide maximum distance. Two-piece balls are made with a single-layer solid core, usually comprised of a crosslinked rubber, which is encased by a cover material. In order to form two-piece balls with rubber cores, the core material must be molded and cured at high temperatures and pressures. Standard compression molding occurs at a cavity pressure of about 4000 p.s.i., at a temperature of about 335° F. for a time of about 11 minutes.

The cover of two-piece balls or multi-layer balls, which comprise at least one intermediate layer, is typically made from a castable material. One such golf ball has a castable cover layer. Forming the castable cover layer usually includes using a pair of mold halves. Each mold half includes a hemispherical cavity into which the castable material and core are deposited in turn. The mold halves are then closed about the core, and the mold is moved to an oven to cure the castable material. Subsequent to curing the castable material, the mold can be moved to a cooling system that includes a large system of conveyers. These conveyers can occupy substantial floor space, which is undesirable. Hence, manufacturers are continuously looking for ways to increase production capacity at minimal cost, use less floor space, and maintain or improve the quality of their product.

### SUMMARY OF THE INVENTION

The method of the present invention can be used not only with cores to decrease molding time, but also with castable materials to improve the efficiency of the heating and/or cooling equipment. The present method can also improve consistency of the golf balls and be used to manufacture a high volume of golf balls.

The present invention is directed to a method of forming at least one substantially-cured golf ball subassemblies by heating partially-cured golf ball subassemblies using a convection oven with a spiral path and/or cooling the partially-cured subassemblies using a cooling unit with a spiral path.

According to one embodiment the method of forming at least one substantially-cured golf ball subassembly comprises the steps: providing at least one partially-cured golf ball subassembly including a partially-cured material; placing the at least one partially-cured golf ball subassembly in a convection oven; flowing heated air at a predetermined curing temperature through the convection oven; moving the at least one partially-cured golf ball subassembly through the convection oven on a vertically spiraling path for a predetermined curing time; and contacting the at least one partially-cured golf ball subassembly with the heated air on the vertically spiraling path to change the partially-cured material into a substantially-cured material and form the at least one substantially-cured golf ball subassembly.

Preferably, a plurality of partially-cured golf ball subassemblies are formed and moved through the convection oven. The plurality of partially-cured golf ball subassemblies includes about 10,000 to about 50,000 subassemblies.

According to one embodiment of the present invention, the method further includes the steps of removing the at least one substantially-cured core from the convection oven and cooling the substantially-cured golf ball subassembly.

According to one aspect of the present invention the cooling step may further include the steps of: placing the at least one substantially-cured golf ball subassembly in a cooling unit; flowing cooled air at a predetermined cooling temperature through the cooling unit; moving the at least one substantially-cured golf ball subassembly through the cooling unit on a vertically spiraling path for a predetermined cooling time; and contacting the at least one substantially-cured golf ball subassembly with the cooled air on the vertically spiraling path to change the substantially-cured golf ball subassembly into at least one cooled substantially-cured golf ball subassembly.

The preferred predetermined cooling temperature is between about 20° F. and about 100° F. The preferred predetermined curing temperature is between about 300° F. and about 500° F. The most preferred predetermined curing temperature is between about 350° F. and about 500° F. The preferred predetermined curing and cooling times are between about 30 minutes and about 60 minutes.

According to one aspect of the present invention, the at least one partially-cured golf ball subassembly includes a partially-cured core. Alternatively, the partially-cured subassembly is a substantially-cured golf ball component surrounded by the substantially-uncured material. In such an embodiment, the substantially-uncured material may be a castable material.

The present invention is also directed to a method of forming at least one cooled substantially-cured golf ball subassembly, and comprises the steps of: providing at least one substantially-cured golf ball subassembly; placing the at least one substantially-cured golf ball subassembly in a cooling unit; flowing cooled air at a predetermined cooling temperature through the cooling unit; moving the at least one substantially-cured golf ball subassembly through the cooling unit on a vertically spiraling path for a predetermined cooling time; and contacting the at least one substantially-cured golf ball subassembly with the cooled air on the vertically spiraling path to change the substantially-cured golf ball subassembly into at least one cooled substantially-cured golf ball subassembly.

### BRIEF DESCRIPTION OF THE DRAWINGS

FIG. 1 is a perspective view of a golf ball formed according to a method of the present invention;

FIG. 2 is a cross-sectional view of the golf ball of FIG. 1;

FIG. 3 is a cross-sectional view of another embodiment of a golf ball formed using the method of the present invention;

FIG. 4 is a flow chart showing the method of making a golf ball subassembly according to a preferred embodiment of the present invention;

FIG. 5 is a schematic representation of a protion of a system for forming a golf ball subassembly according to the method of FIG. 4;

FIG. 6 is an enlarged, perspective view of a spiral belt stack for use in the system of FIG. 5;

FIG. 7 is an enlarged, perspective view of a convection oven for use in the system of FIG. 5, wherein portions of a housing are omitted for clarity;

FIG. 8 is an enlarged, perspective view of a cooling unit for use in the system of FIG. 5, wherein portions are broken away for clarity; and

FIG. 9 is a schematic, plan view of a process for forming a layer of castable material using the method of the present invention.

### DESCRIPTION OF THE PREFERRED EMBODIMENTS

Referring to FIGS. 1 and 2, a method of the present invention can be used to make a golf ball 10, which comprises a core 12 surrounded by at least one cover layer 14. The cover layer 14 forms the outer surface of the ball 10 and defines dimples 16 therein. In the golf ball 10, the core 12 is the golf ball subassembly S and is of a molded, solid construction.

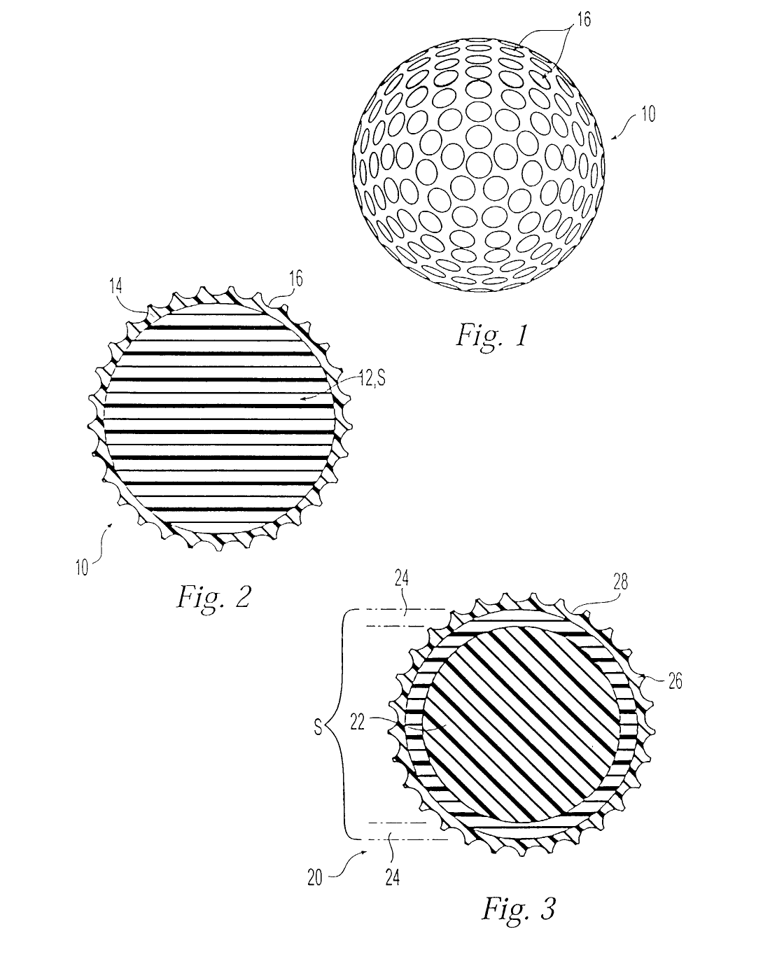

Referring to FIG. 3, the method of the present invention can be used to make a golf ball 20 that includes a core 22 surrounded by at least one intermediate layer 24, which is surrounded by a cover 26. The core 22 and the intermediate layer 24 form the golf ball subassembly S. The cover 26 defines dimples 28.

Although the golf balls 10 and 20 are shown with solid cores 12 and 22, respectively, the present invention can also be used with cores that have fluid-filled centers. The fluid within the core center can be a wide variety of materials including air, water solutions, liquids, gels, foams, hot-melts, other fluid materials and combinations thereof, as known by those of ordinary skill in the art.

Furthermore, depending on the construction of the golf ball the golf ball subassembly may include a core surrounded by a plurality of intermediate layers. Such a golf ball subassembly may also include a single or multi-layer cover. The golf ball subassembly may also include a core surrounded by a single intermediate layer, and a single or multi-layer cover. The golf ball subassembly is simply the portion of the golf ball that is subjected to the post-molding processing of the present invention as discussed in detail below.

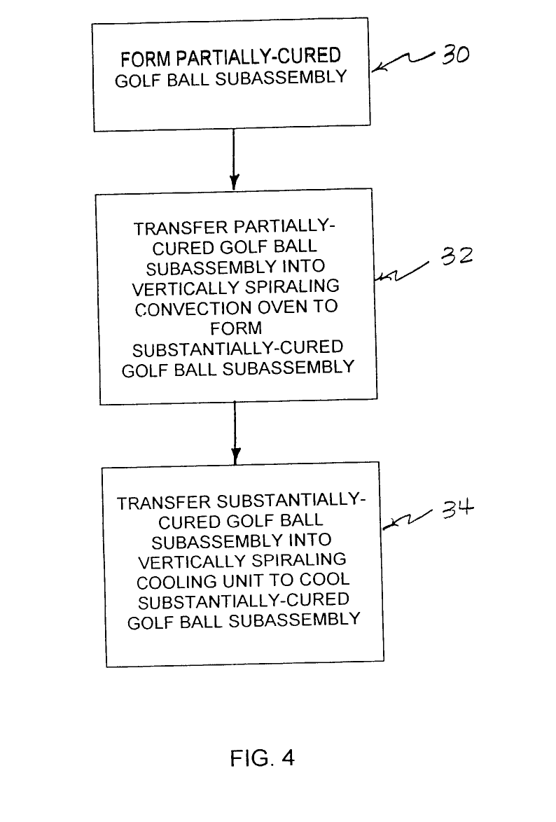

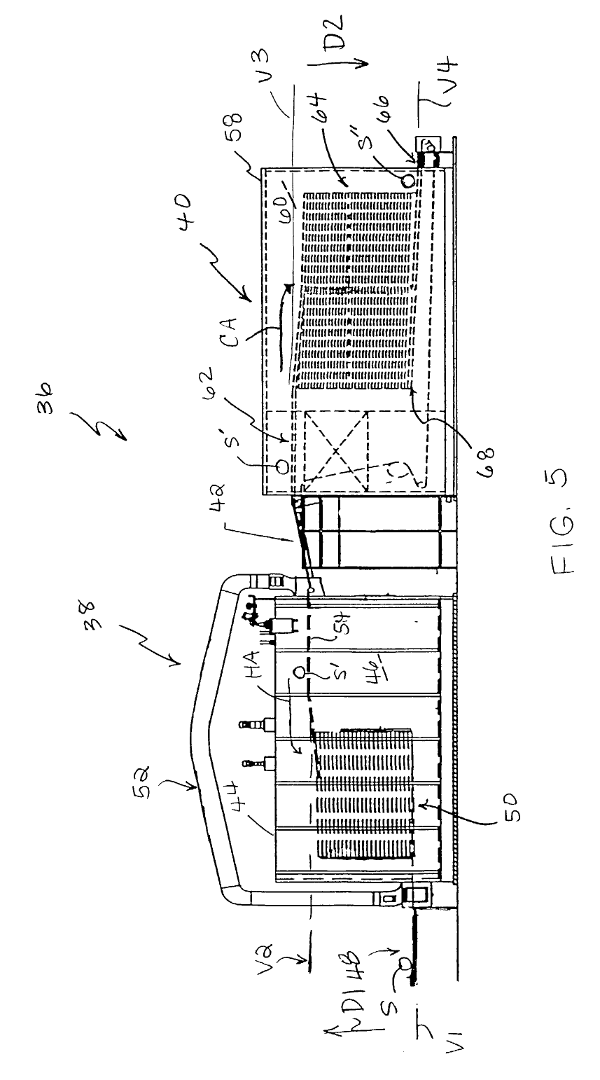

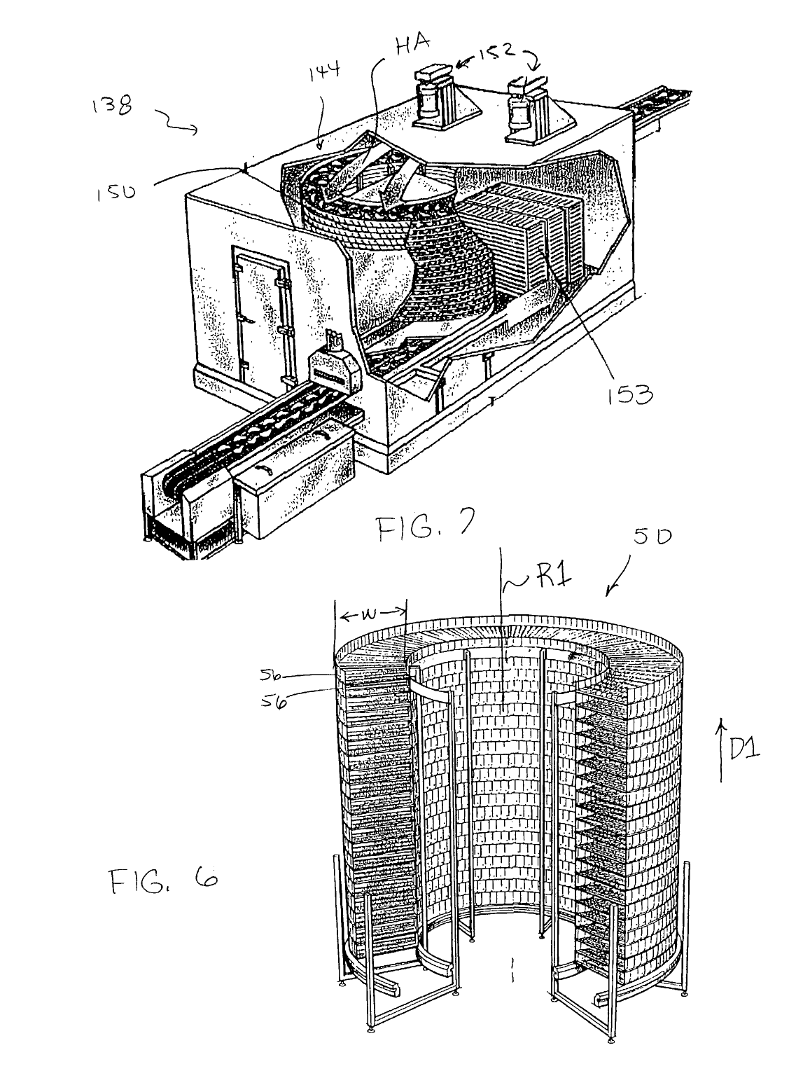

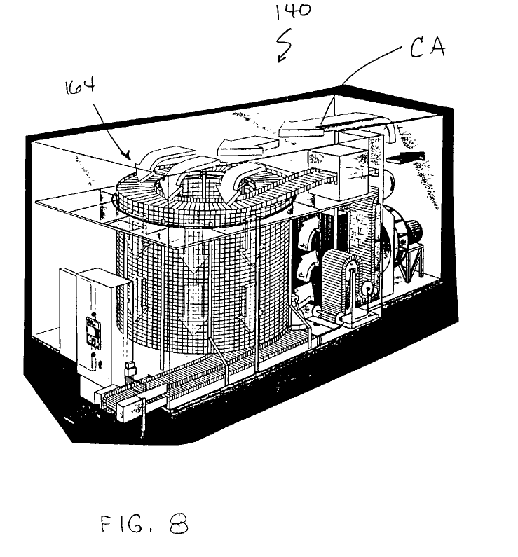

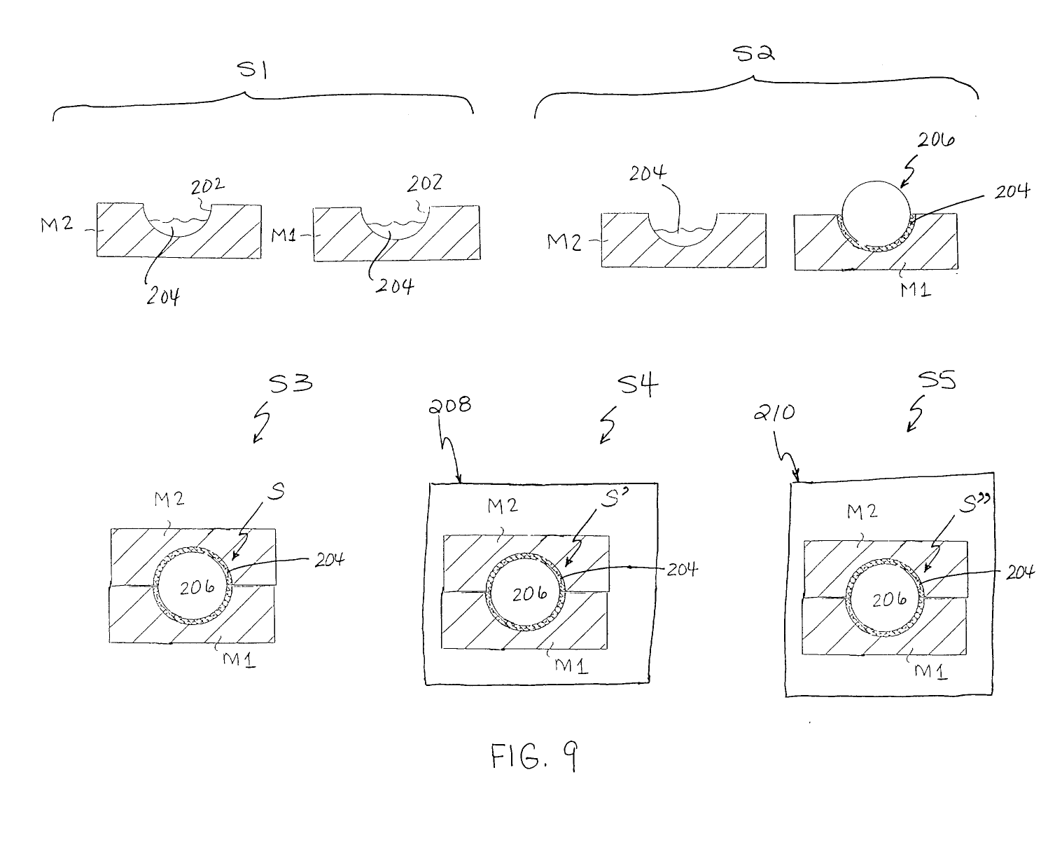

Referring to FIG. 4, the method of making golf balls 10 and 20 (as shown in FIGS. 2 and 3) according to a preferred embodiment of the present invention generally includes steps 30-34 and will now be discussed. Step 30 includes forming a partially-cured golf ball subassembly S (as shown in FIGS. 2 and 3) or a plurality of such subassemblies depending on the construction of the golf ball subassembly.

If the partially-cured golf ball subassemblies S are cores, as shown in FIG. 2, the core may be formed using conventional compositions and techniques as known by those of ordinary skill in the art. Forming the core generally includes: (1) forming a preform or prepreg suitable for molding, and (2) compression molding the prepreg into a partially-cured core or subassembly. Compression molding can be performed with a core molding press or other compression molding equipment well known to one of ordinary skill in the art.

As used herein with respect to a golf ball core subassembly, the terms “partially” cured and “substantially” cured refer to relative amounts of reacted crosslinking agent that has been added to the preform material at a predetermined level to achieve the required crosslink density. Crosslink density ultimately determines the hardness of the cured material as measured in golf balls as compression. A “substantially” cured core has as much of the crosslinking agent reacted as possible within the limits of the ability to mix the core material and obtain even distribution of crosslinking agent throughout the mixture. A “partially” cured core is anything less than “substantially” cured. The amount of crosslinking can be determined empirically or the amount of curing can be determined using the performance characteristics of the core, such as core compression. Using core compression, a “substantially” cured core may have a core compression within a predetermined range of a target core compression. “Partially” cured also means that the core material crosslinks sufficiently so that the core material retains the geometry of a cavity in the mold, but is not crosslinked to a completely cured state. Before the core material is “partially” cured, it is too soft or fluid-like and cannot retain the cavity geometry.

After step 30 of forming the partially-cured golf ball subassemblies S is completed, the partially-cured golf ball subassemblies S are removed from the compression mold and transferred into a post cure system 36, as shown in FIG. 5. In FIG. 5 single subassemblies S, S′, and S″ are shown. The post cure system 36 includes a convection oven 38 and a cooling unit 40 joined to the oven 38 by a conveyer belt 42. In a preferred embodiment, the convection oven 38 substantially couples the curing process of subassemblies S, and cooling unit 40 that reduces the temperature of the substantially-cured subassemblies S to handling temperature. The convection oven 38 includes a housing 44 for defining a chamber 46 therein, an entrance conveyer belt 48, a vertically spiraled belt assembly 50, a heat exchanger (not shown), an apparatus 52 for recirculating heated air, HA, through the chamber 46, and an exit conveyer belt 54.

The size of the chamber 46 may be selected to provide the desired capacity. The entrance conveyer belt 48 moves the partially-cured golf ball subassemblies S into the chamber 46 at a first vertical position V1. The partially-cured golf ball subassemblies S can be delivered to the entrance conveyer belt 48 via an automated system of conveyers from the compression molds or via a manual system of steel totes and/or hoppers.

The entrance conveyer belt 48 is operatively associated with the spiraled belt assembly 50 so that the subassemblies S are moved from the belt 48 on to the belt assembly 50 automatically. The spiraled belt assembly 50 defines a vertically spiraling path for the partially-cured golf ball subassemblies S. Preferably, if a plurality of subassemblies are processed they are arranged on the belt in a single layer and may or may not be in contact with one another.

The belt assembly 50, as shown in FIG. 6 includes a plurality of vertically spaced apart perforated curing supports or racks 56. The supports 56 are preferably metal and rotatable about an axis R1. As the supports 56 rotate, the golf ball subassemblies S thereon move in a vertically upward direction D1. The width of the belt, w, can be selected to achieve the desired capacity. In a preferred embodiment, the spiraled belt assembly 50 is configured and dimensioned to accommodate a plurality of partially-cured golf ball subassemblies. More preferably, the plurality of partially-cured golf ball subassemblies accommodated is between about 10,000 and about 50,000 subassemblies.

The heat exchanger (not shown) heats air to a predetermined curing temperature to provide heated air HA. In the embodiment shown, the heated air HA is flowed continuously through the oven chamber 46 using the recirculating apparatus 52. The recirculating apparatus 52 allows the heated air HA to contact the partially-cured golf ball subassemblies S continuously on the spiraled belt assembly 50 for a predetermined curing time and change the partially-cured material therein into a substantially-cured material to form a substantially-cured golf ball subassemblies S′.

The exit conveyer belt 54 is preferably positioned at a second vertical position V2 above first vertical position V1. As a result, belt 54 is operatively associated with the top of the spiraling belt assembly 50 and the substantially-cured golf ball subassemblies S′ are automatically transferred from the spiraling belt assembly 50 to the belt 54. The present invention is not limited to these positions of belts 48 and 54.

In a preferred embodiment, the subassemblies S′ are spiraled in the vertically upward direction D1, and the heated air HA is flowed through the spiraled belt assembly 50 in a vertically downward direction D2. The present invention, however, is not limited to these directions and, for example, in an alternative embodiment the subassemblies may be spiraled vertically downward in direction D2, and the heated air HA may be flowed upward in direction D1.

Compression molding should be performed at a cavity pressure, a predetermined molding temperature or cavity temperature, and for a predetermined molding time or molding time sufficient for the preform to achieve a partially-cured state substantially below 100%. The cavity pressure should range from about 1,800 p.s.i. to about 10,000 p.s.i., and it is preferred that the cavity pressure range from about 3,000 p.s.i. to about 4,000 p.s.i. It is preferred that the molding temperature is between about 250° F. and about 500° F. for a preferred molding time of between about 3 minutes and about 30 minutes. Preferably, the molding temperature is between about 300° F. and about 400° F. for the preferred molding time of between about 6 minutes and about 20 minutes. Most preferably, the molding temperature is between about 325° F. and about 375° F. for the molding time of between about 7 minutes and about 12 minutes.

When using compression molding to form the partially-cured golf ball subassembly, the predetermined curing temperature of the heated air is substantially greater than the predetermined molding temperature. Preferably, the predetermined curing temperature is between about 200° F. and about 500° F. More preferably, the predetermined curing temperature is between about 350° F. and about 500° F. The preferred predetermined curing time is between about 30 minutes and about 60 minutes. These preferred temperatures and times are for a rubber core material and will vary depending on the material being cured.

The cooling unit 40 includes a housing 58 for defining a chamber 60 therein, an entrance conveyer belt 62, a vertically spiraled belt assembly 64, a chiller such as a compressor (not shown), an apparatus (not shown) for recirculating cooled air, CA, through the chamber 60, and an exit conveyer belt 66.

The size of the chamber 60 may be selected to provide the desired capacity. The entrance conveyer belt 62 is operatively associated with the spiraled belt assembly 64 so that the subassemblies S′ are deposited from the belt 62 on to the spiraling belt assembly 64 automatically. The entrance conveyer belt 62 moves the substantially-cured golf ball subassemblies S′ into the chamber 60 at a third vertical position V3. The third vertical position is preferably substantially aligned with the second vertical position V2 to make the system 36 efficient.

The subassemblies S′ are delivered to the entrance conveyer belt 62 via an operative association between a belt 42 and conveyer belt 62. In an alternative embodiment, a single belt can be used to transfer the subassemblies between spiraling belt assemblies 50 and 64. In yet another alternative embodiment, the conveyer belt 42 can be optional and other means such as manual means can be used to transfer the subassmblies S′ between the oven 38 and cooling unit 52.

The belt assembly 64 defines a vertically spiraling path for the substantially-cured golf ball subassembly S′. The belt assembly 64 is similar to belt assembly 50, as shown in FIG. 6, and includes a plurality of vertically spaced apart, perforated curing supports 68 that rotate. Preferably, the subassemblies S′ are arranged on the supports 68 in a single layer and may or may not be in contact with one another. As the belt assembly 64 rotates, the golf ball subassembly S′ thereon move in a vertically downward direction D2. The width of the belt 64 can be selected to achieve the desired capacity. In a preferred embodiment, the spiraled belt assembly 50 is configured and dimensioned to accommodate a plurality of substantially-cured golf ball subassemblies S′. More preferably, the plurality of substantially-cured golf ball subassemblies accommodated is between about 10,000 and about 50,000 subassemblies.

The chiller (not shown) cools air to a predetermined cooling temperature to provide cooled air CA. In the embodiment shown, the cooled air CA is flowed through the cooling unit chamber 60 using the recirculating apparatus. The recirculating apparatus allows the cooled air CA to contact the substantially-cured golf ball subassemblies S′ continuously on the spiraled belt assembly 64 for a predetermined cooling time and change the substantially-cured subassemblies S′ into a cooled substantially-cured golf ball subassemblies S″. The cooled subassemblies S″ are preferably cooled to a handling temperature of about 65° F. to about 85° F.

In a preferred embodiment, the subassemblies S″ are spiraled in a vertically downward direction D2, and the cooled air CA is flowed through the spiraled belt assembly 64 in a vertically downward direction D2. The present invention, however, is not limited to these directions and, for example, in an alternative embodiment the subassemblies may be spiraled vertically upward in direction D1, and the cooled air CA may be flowed downward in direction D2.

The exit conveyer belt 66 is preferably positioned at a fourth vertical position V4 lower than third vertical position V3. As a result, belt 66 is operatively associated with the bottom of the spiraling belt assembly 64 and the cooled substantially-cured golf ball subassemblies S″ are automatically transferred from the belt assembly 64 to the exit belt 66. The present invention is not limited to these positions of belts 62 and 66. Most preferably, the first and fourth vertical positions V1 and V4 are less than about 5 feet from floor level so that workers on the factor floor can easily access the subassemblies S and S″ and no additional equipment is necessary to return the subassemblies S and S″ to floor level.

The predetermined cooling temperature of the cooled air is substantially less than the predetermined curing and molding temperatures. Preferably, the predetermined cooling temperature is between about 20° F. and about 100° F. More preferably, the predetermined cooling temperature is between about 40° F. and about 60° F. The preferred predetermined cooling time is between about 30 minutes and about 60 minutes. These preferred temperatures and times are for a rubber core material and will vary depending on the material being cured.

In an alternative embodiment, the post-mold heating/final cure process can be used with alternative cooling processes such as cooling substantially-cured subassemblies with room temperature air or cooling substantially-cured subassemblies in cooling units that do not move the subassemblies along spiraled paths. Furthermore, in an alternative embodiment, the post-cure cooling process can be used with alternative forming processes, such as conventional subassembly formation or processes where the subassemblies are partially-cured by molding and post-mold final cured by a variety of methods. For example, the post-mold final cure can be accomplished by contacting the subassemblies with a medium. The medium can be solid particles such as ceramic pellets, metals, glass particles, or sand or a fluid such as air or a non-penetrating liquid or a combination thereof, where the subassemblies are not moved along spiraled paths. Such a process is disclosed in U.S. patent application Ser. No. 09/924,348; filed on Aug. 8, 2001.

After the cooling process, the subassemblies S″ can be discharged from the system for storage or further processing, such as covering and painting, using conventional techniques.

In one embodiment, as shown in FIG. 7, a preferred convection oven 138 may be a commercially available GCO GYRoCOMPACT OVEN manufactured by FMC FoodTech of Chicago, Ill. In oven 138, the heated air HA is moved by circulating fans 152 and a heat exchanger 153 is within the housing 144. In addition, stacked belt 150 is commercially available from FMC FoodTech under the name GCO 106 Belt Support System. In one embodiment, as shown in FIG. 8, a preferred cooling unit 140 may be a commercially available GCO GYRoCOMPACT FREEZER manufactured by FMC FoodTech. In cooling unit 140, stacked belt 164 is also commercially available from FMC FoodTech. Alternatively, other belts and ovens made by this manufacturer, such as the GCO 76 or GCO 106CR Belt Support System, or equipment by other manufacturers can be used. The main criteria for selecting the ovens, cooling units and belts are the size of the equipment and the production rate.

Referring to FIG. 9, the post-mold curing and cooling treatments can be used with a casting process 200 that includes steps S1-S5. In step S1, a pair of mold halves M1 and M2 each including a hemispherical cavity 202 are provided and a partially-cured material 204 is disposed within each hemispherical cavity 202. The material 204 may be a castable material, such as urethane. A substantially-cured golf ball component 206 is located within one of the hemispherical cavities 202 as shown in step S2. The pair of mold halves M1 and M2 are then closed in step S3 forming a partially-cured golf ball subassembly S.

In step S4, the preferred curing temperature for a castable material may be less than about 425° F. More preferably, the curing temperature for a castable material is between about 200° F. and about 300° F. with a preferred curing time of about 30 minutes. In step S5, the preferred cooling temperature for a castable material may be less than about 100° F. More preferably, the cooling temperature for a castable material is between about 50° F. and about 60° F. with a preferred curing time of about 30 minutes. Once process 200 is complete, the material 204 can form an intermediate layer of the golf ball or an inner or outer cover layer.

As shown by experimentation in application Ser. No. '348, the inventive method should result in cores or subassemblies having a higher average compression than components made according to conventional compression molding techniques alone. The inventive method should also produce cores or subassemblies having a more consistent range of compressions with a shorter mold time. Using spiraling heating and cooling may also provide more even heating and cooling for other more consistent golf ball properties and high volume production.

While the above invention has been described with reference to certain preferred embodiments, it should be kept in mind that the scope of the present invention is not limited to these embodiments. One skilled in the art may find variations of these preferred embodiments, which, nevertheless, fall within the spirit of the present invention, whose scope is defined by the claims set forth below.

What is claimed is:

1. A method of forming at least one substantially-cured golf ball subassembly comprising the steps of:
a. providing at least one partially-cured golf ball subassembly including a partially-cured material;
b. placing said at least one partially-cured golf ball subassembly in a convection oven;
c. flowing heated air at a predetermined curing temperature through said convection oven;
d. moving said at least one partially-cured golf ball subassembly through said convection oven on a vertically spiraling path for a predetermined curing time; and
e. contacting said at least one partially-cured golf ball subassembly with said heated air on said vertically spiraling path to change said partially-cured material into a substantially-cured material and form said at least one substantially-cured golf ball subassembly.

2. The method of claim 1, further including forming a plurality of partially-cured golf ball subassemblies and moving said plurality of partially-cured golf ball subassembly through said convection oven, wherein said plurality of partially-cured golf ball subassemblies includes about 10,000 to about 50,000 partially-cured golf ball subassemblies.

3. The method of claim 1, further including the steps of removing said at least one substantially-cured core from said convection oven and cooling said substantially-cured golf ball subassembly.

4. The method of claim 3, wherein said step of cooling said substantially-cured golf ball subassembly further includes:
placing said at least one substantially-cured golf ball subassembly in a cooling unit;
flowing cooled air at a predetermined cooling temperature through said cooling unit;
moving said at least one substantially-cured golf ball subassembly through said cooling unit on a vertically spiraling path for a predetermined cooling time; and
contacting said at least one substantially-cured golf ball subassembly with said cooled air on said vertically spiraling path to change said substantially-cured golf ball subassembly into at least one cooled substantially-cured golf ball subassembly.

5. The method of claim 4, wherein the predetermined cooling temperature is between about 20° F. and about 100° F.

6. The method of claim 5, wherein the predetermined cooling temperature is between about 40° F. and about 60° F.

7. The method of claim 5, wherein the predetermined cooling time is between about 30 minutes and about 60 minutes.

8. The method of claim 1, wherein said at least one partially-cured golf ball subassembly is a core.

9. The method of claim 1, wherein the predetermined curing temperature is between about 300° F. and about 500° F.

10. The method of claim 1, wherein the predetermined curing temperature is between about 350° F. and about 500° F.

11. The method of claim 1, wherein the predetermined curing time is between about 30 minutes and about 60 minutes.

12. The method of claim 1, wherein said at least one partially-cured golf ball subassembly includes a substantially-cured golf ball component and said substantially-uncured material surrounds said substantially-cured golf ball component.

13. The method of claim 12, wherein said partially-cured material is a castable material.

14. The method of claim 12, wherein said step of providing at least one golf ball subassembly further includes:
providing at least one pair of mold halves each with a hemispherical cavity;
disposing said partially-cured material within said hemispherical cavity of each mold half;
locating said substantially-cured golf ball component within a one of said hemispherical cavities; and
closing said pair of mold halves about said at least one substantially-cured golf ball component to form said at least one partially-cured golf ball subassembly.

15. The method of claim 14, wherein said substantially-cured golf ball component is a golf ball core.

16. The method of claim 14, wherein said substantially-cured material forms an additional layer on said golf ball core.

17. The method of claim 14, wherein said substantially-cured golf ball component is a golf ball core surrounded by at least one intermediate layer and said substantially-cured material forms an additional layer on said substantially-cured golf ball component.

18. A method of forming at least one cooled substantially-cured golf ball subassembly comprising the steps of:
a. providing at least one substantially-cured golf ball subassembly;
b. placing said at least one substantially-cured golf ball subassembly in a cooling unit;
c. flowing cooled air at a predetermined cooling temperature through said cooling unit;
d. moving said at least one substantially-cured golf ball subassembly through said cooling unit on a vertically spiraling path for a predetermined cooling time; and
e. contacting said at least one substantially-cured golf ball subassembly with said cooled air on said vertically spiraling path to change said substantially-cured golf ball subassembly into at least one cooled substantially-cured golf ball subassembly.

19. The method of claim 18, wherein said substantially-cured golf ball subassembly is a golf ball core surrounded by at least one additional layer.

20. The method of claim 19, wherein said additional layer is formed of a castable material.
